(19) United States
(12) Patent Application Publication
(10) Pub. No.: US 2010/0033430 A1
(43) Pub. Date: Feb. 11, 2010

(54) IMAGE REPRODUCTION DEVICE FOR AV DEVICE

(75) Inventors: Koichiro Kakutani, Saitama (JP); Shingo Suzuki, Saitama (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION, Meguro-ku (JP)

(21) Appl. No.: 12/529,756

(22) PCT Filed: Mar. 6, 2007
(86) PCT No.: PCT/JP2007/054335

§ 371 Date: Sep. 3, 2009

(51) Int. Cl. G06F 3/033; G06K 9/46; G08C 19/00; G06K 9/36

(52) U.S. Cl. 345/157; 382/190; 340/825.69; 382/284

(57) ABSTRACT

Object To provide an image reproduction device for remotely reproducing image information from an AV device and facilitating remote operation of the AV device,

Configuration An image reproduction device whereby image content and at least one menu image are acquired from an AV device via a communication network and reproduced on a monitor screen, whereby arrangement information concerning a plurality of menu selection branches in said menu image is stored for each menu image. The image reproduction device also identifies the in-reproduction menu image being reproduced, decides on one of the menu selection branches from among the plurality of selection branches in the in-reproduction menu image in accordance with the pointing information for the monitor image, and generates a menu selection signal in accordance with the first menu selection branch which is supplied to said AV device via said communication network.

### TECHNICAL FIELD

The present invention relates to an image reproduction device whereby image signals output by an AV device such as video tape recorder (VTR) or DVD/HDD recorder are acquired via a communications network such as the Internet and then reproduced.

### BACKGROUND ART

AV device such as video tape recorders (VTRs) and DVD/HDD recorders normally output image signals to external TV monitors and are provided with a remote control function whereby operational control of the AV device is performed remotely with a remote controller that employs a signal such as infrared light (“remote controller” below). In operations carried out by the remote controller, for example, the desired selection or item contained in a menu screen reproduced on a TV monitor (“menu screens” below) is selected by movement of a pointer of the remote controller and made to flash, whereupon the enter key is pressed in response thereto. An command is thereby issued, such as a program listing display command.

When the AV device is used, it is not merely the case that the AV device or TV monitor is operated from a nearby position; remote viewing may need to be performed from a separate room in a house or from a terminal at a travel destination. Technologies that allow remote viewing of this type are the technologies described in patent document 1 and patent document 2.

With these technologies, a standalone image reproduction device such as a portable data terminal or personal computer (“PC” below) is used, and a remote control virtual image is displayed along with an image of the menu screen that is generated by the AV device on the display screen. The user can thus see entry of commands using a touch panel, keyboard, or the like on the remote control that is displayed on the image reproduction device. This configuration has the advantage that remote operation of the AV device can be carried out using commonly performed operations.

Patent document 1: Japanese Patent Kokai No. 10-112889

Patent document 2: Japanese Patent No. 3849719

### DISCLOSURE OF THE INVENTION

### Problems to be Solved by the Invention

However, in these conventional modes, the controller used for remote operation must be operated from even farther away; i.e., an extended remote operation must be performed. This extended remote causes delay in response to the operational commands or prevents direct operation, which can inconvenience the user.

A problem to be solved by the invention, taking the above problem as an example, is to provide an image reproduction device that facilitates remote operation of an AV device while also reproducing image content from the AV device.

### MEANS FOR SOLVING THE PROBLEMS

The image reproduction device according to the present invention is an image reproduction device for acquiring image content and at least one menu image from an AV device via a communication network and reproducing the image content or menu image on a monitor screen, the image reproduction device characterized in comprising: menu arrangement information storage means for storing, for each of the menu images, arrangement information for a plurality of menu selections on the menu image; menu image identification means for identifying the in-reproduction menu image being reproduced; menu selection branch determining means for determining, in accordance with a pointing information input corresponding to the monitor screen, one menu selection branch corresponding to the pointing information from among a plurality of menu selection branches in the in-reproduction menu image, on the basis of the arrangement information for the in-reproduction menu image; and menu selection signal supply means for generating a menu selection signal corresponding to the menu selection branch that has been decided on, and supplying the signal to the AV device via the communication network.

### BEST MODE FOR CARRYING OUT THE INVENTION

Embodiment of the present invention are described in detail below in reference to the attached drawings.

FIG. 1 shows an embodiment of the present invention and presents the overall structure including the image reproduction device. An AV device 30 such as a video tape recorder (VTR) or DVD/HDD recorder is disposed in area A1, and an image reproduction device 60 is disposed in area A2, which acquires image signals output from the AV device 30 via a telecommunication network 20 and carries out image reproduction processing on the image signal. The area A1 and area A2 are not defined, but are presumed to be, for example, in locations that are remote from one another, such as between the living room and a separate room, or a location within the home and a travel destination.

The AV device 30 is connected to an ordinary TV monitor 40 that reproduces the image signals output from the AV device 30 and from an AV server 50 into which the image signal from the AV device 30 is input via an AV cable 33. In addition, the AV device 30 has a receiving part 31 that receives remote control code signals from the remote controller 32 (“remote controller 32” below) for remote operation in accordance with a menu screen display. The remote controller 32 has a channel number indication button, a button pointer movement button, an enter indication button and various other buttons for controlling operation of the AV device 30. A function is thus provided whereby remote controller code signals are sent to the receiving part 31 of the AV device 30 when these buttons are pressed. For example, an infra-red transmission system is used as the communication system for the remote controller code signals.

The AV server 50 is a server that distributes image signals of the menu screen or image content output from the AV device 30 to a terminal comprising an image reproduction device 60 via a communication network 20. As is appropriate for the communication network 20, the AV server 50 has a signal conversion function whereby the coding form and coding rate are converted with respect to the image signals output from the AV device 30 or a signal transmission function whereby image signals that have been converted are sent to the communication network 20, and a remote control code transmission function whereby the remote control code signals supplied by the image reproduction device 60 via the communication network 20 are converted to a communication format (e.g., infrared light) that is acceptable to the AV device 30 and are then sent to the AV device 30. The remote control code signals that have been transmitted are supplied via a communication network between a transmission part 51 provided on the AV server 50 and a receiving part 31 provided on the AV device 30.

The image reproduction device 60 is realized by a common personal computer (also “PC” below), which is connected to the communication network 20, the PC monitor 80 that regenerates the image signals, and a mouse device 70 (“mouse 70” below) for acquiring pointing information including the positional coordinates on the screen display field of the PC monitor 80.

FIG. 2 shows the internal configuration of the image reproduction device shown in FIG. 1. The image reproduction device 60 has a PC control/image reproduction part 61, a mouse control part 62, a menu screen identification part 63, an item designation detection part 64, a remote control code transmission part 65, a menu arrangement information database 66, and a menu arrangement information setting part 67.

The PC control/image reproduction part 61 has an ordinary computer control function and a conversion reproduction function whereby the image signals distributed via the communication network 20 are decoded and expanded, and thereby converted into image signals that can be regenerated on the PC monitor 80. The mouse control part 62 has a function whereby it acquires pointing data from the mouse 70 and detects clicking operation commands or coordinate data of the pointer within the display field of the PC monitor 80.

The menu screen identification part 63 has a function whereby it decides whether the image displayed in the display field of the PC monitor 80 is on the menu screen of the AV device, based on the content of the menu arrangement information database 66. The item designation detection part 64 has a function whereby it compares the coordinate information of the item on the menu screen that has been decided and the coordinate information detected by the mouse control part 62 in accordance with detection of a click operation instruction detected by the mouse control part 62, and decides whether the selected or specified item has been designated based on the menu arrangement information database 66.

The remote controller code transmission part 65 acquires remote controller codes corresponding to this item from the menu arrangement information database 66 when it is determined that the specified item has been designated, generates the remote controller code signals corresponding to the remote controller codes as menu selection signals, and transmits them to the AV server 50 via the communication network 20.

The menu arrangement information database 66 is a database in which menu arrangement information that specifies positional relationship such as the layout of the item is stored and establishes the recognition information for each menu screen; the configuration, identification information or positional information of the items contained in the menu screens; as well as the corresponding remote controller codes.

The menu arrangement information setting part 67 has a function whereby the menu arrangement information provided externally is acquired and this information is entered in the menu arrangement information database 66. The menu arrangement information setting part 67 may also have a function whereby menu arrangement information is acquired regularly or periodically from a site that is provided on the communication network by the AV device manufacturer, thereby automatically updating the content of the menu arrangement information database 66.

FIG. 3 is an installation example of the menu arrangement information database shown in FIG. 2. For example, as shown in the drawing, the menu arrangement information database 66 contains menu arrangement information in a tabular format, and, for each of the menu screens, establishes identification information for the manufacturer providing the AV device, identification information for the AV device, identification information for image recognition whereby the menu screen is recognized, item identification information, coordinate information, and other menu layout information. For example, when “Main menu” is set as the identification information of a menu screen in the AV device, coordinate information “X (280, 380) and Y (350, 1550)” and remote control code “0000101000” are set as navigation items on the menu screen. The identification information for the menu screen is information whereby the menu screen can be recognized by image recognition, and, in particular, data of specified character sequences or specified shapes is established. The coordinate information normally can be displayed on coordinates indicating the position and size of a square area, but may also be displayed using a combination of radii and center coordinates of circular areas (refer to FIG. 6). In addition, complex shapes can also be defined by using multiple coordinate data.

FIG. 4 shows the entire processing sequence including the image reproduction device according to the present invention. The processing sequence is carried out by cooperative functioning of the AV device 30, AV server 50, and image reproduction device 60.

First, the image reproduction device 60 establishes the menu arrangement information in accordance with input of menu arrangement information (step S1). Input of the menu arrangement information may be achieved when the user performs a manual operation to input the menu arrangement information provided by the AV device manufacturer; when the user downloads and inputs the information from a site on a communication network provided by the AV device manufacturer; or when the information is regularly or periodically updated using an automated update function.

The AV device 30 outputs the image of the menu screen to the AV server 50 at the time when the power supply is turned on (step S2). The AV server 50 distributes an output menu screen image to the image reproduction deice 60 (step S3). At this point, the AV server 50 distributes the image signals for the menu screen to the image reproduction device 60 as a packet-form image signal by adjusting the bit rate or by compression and encoding to allow distribution via the communication network.

The image reproduction device 60 receives the distributed image signal packet and reproduces the menu screen image by carrying out decoding and expansion as appropriate (step S4). In this state, the user of the image reproduction device 60 performs pointer movements and clicking functions by operating the mouse on the menu screen, and the desired item on the menu screen is designated, allowing the pointing information to be entered.

In accordance with input of the pointing information by the viewer, the image reproduction device 60 acquires the pointing information (step S5). Next, the image reproduction device 60 recognizes the item designation along with identification of the menu screen (step S6). Identification of the menu screen, for example, is carried out using a method involving character recognition of specified character sequences such as the screen title or a method whereby the shape of a specified shape in the menu screen is recognized. The method for detecting item designation in the menu screen involves referring to a menu arrangement information database, and determining whether or not a specified item from among the multiple items displayed on the menu screen has been designated based on the coordinate information thereof. Specifically, in determining whether or not a specified item has been indicated, a comparison is made of coordinate information displaying the pointing information and coordinate information for the various items stored in a menu arrangement information database; and when the coordinate information representing the pointing information is determined to be, for example, within the square area that represents the coordinate information for an item, a detection is made that the item has been indicated.

Next, the image reproduction device 60 generates remote control code signals in accordance with the detected item, and the generated remote control code signals are sent to the AV server 50 (step S7). Correspondence of the designated specific item and the remote control code signal is achieved using the menu arrangement information database. The sent remote control codes are then relayed to the AV device 30 by the AV server 50 (step S8). If a remote control that employs an infrared communication format is used, then the remote control codes are modulated to infrared signals and sent off, thereby allowing operations to be carried out in the same manner as standard remote control.

The AV device 30 demodulates and acquires the remote control codes that have been sent by infrared light and performs the operations corresponding to the remote control codes (step S9). Specifically, the AV device 30 outputs an image of the screen corresponding to the item designation in the image reproduction device 60 (step S10). For example, when a navigation item has been designated, an operation is carried out involving transition to the navigation screen.

The AV server 50 distributes the image signals of the screen that is to be displayed after the transition to the image reproduction device 60 (step S11). The image reproduction device 60 generates image signals for the distributed screen, and, specifically, regenerates the image of the screen corresponding to the item designation (step S12).

FIG. 5 shows a display example of the image reproduction device pertaining to the present invention. The PC monitor screen 81 displays the remote control composite image 83 along with the TV monitor display image 82 displayed on the TV monitor that is connected to the AV device. Recognition information 820 such as the screen title “main menu” for identifying the screen as well as a plurality of selection branches of the menu selection subjects, specifically, items 821 to 82n (where n is an integer), are displayed on the TV monitor screen image 82 during reproduction of the menu screen. The viewer of the PC monitor moves the pointer 84 over the PC monitor screen 81 by operating the mouse, and a specific item in the TV monitor display image 82, e.g., item 822 “program listing” is directly designated and clicked upon, allowing a command to be made so that the screen will change to the corresponding program listing screen. In addition, by designating and clicking on the cursor key 831 in the remote control composite image 83 produced using CG technology, attention is brought to the specified item and it is made to flash. In addition, the Confirm key (OK key) 832 can be designated in connection and clicked in order to carry out a similar command.

By utilizing the image reproduction device according to the present invention in the embodiment described above, remote reproduction of image content from an AV device can be carried out on a PC or portable terminal in a location that is distant from the AV device. Moreover, the operations of the AV device that are normally performed using a remote control can be directly made to operate on the menu screen of the AV device displayed through a display screen on the portable unit or PC. It is thus possible to decrease access delay on the communications network and to eliminate user error in performing operations by indirect operation using remote control keys. Moreover, the items of the menu screen can be operated directly using a mouse, and thus the operability of the GUI (graphical user interface) is improved, and stress on the part of the viewer is reduced because a natural operating feel is achieved.

### INDUSTRIAL APPLICABILITY

The image reproduction device according to the present invention can be utilized in various devices such as portable telephones, personal computers, or PDAs. The AV device presented in the embodiments may be an AV device that outputs image signals for a menu screen for controlling operation along with image signals or audio signals of the content to be watched. For example, a television with a built-in HDD, a DVD recorder, a DVD player, a Blu-ray disk player or recorder, or another device can be envisioned.

### BRIEF DESCRIPTION OF THE DRAWINGS

FIG. 1 is a block diagram showing the overall configuration of an embodiment of the present invention, including the image reproduction device;

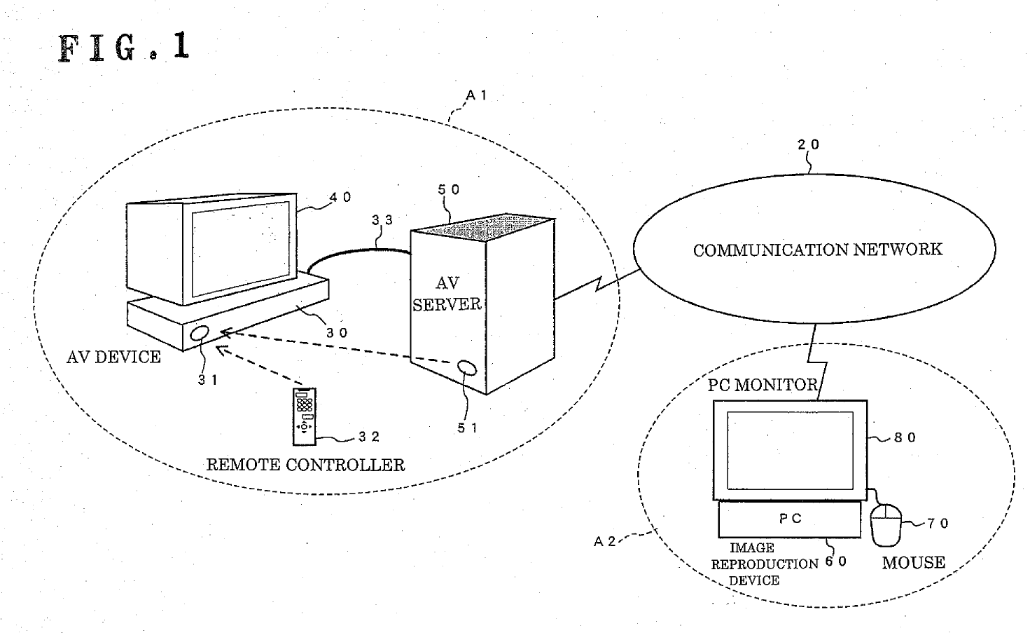

FIG. 2 is a block diagram showing the internal configuration of the image reproduction device shown in FIG. 1;

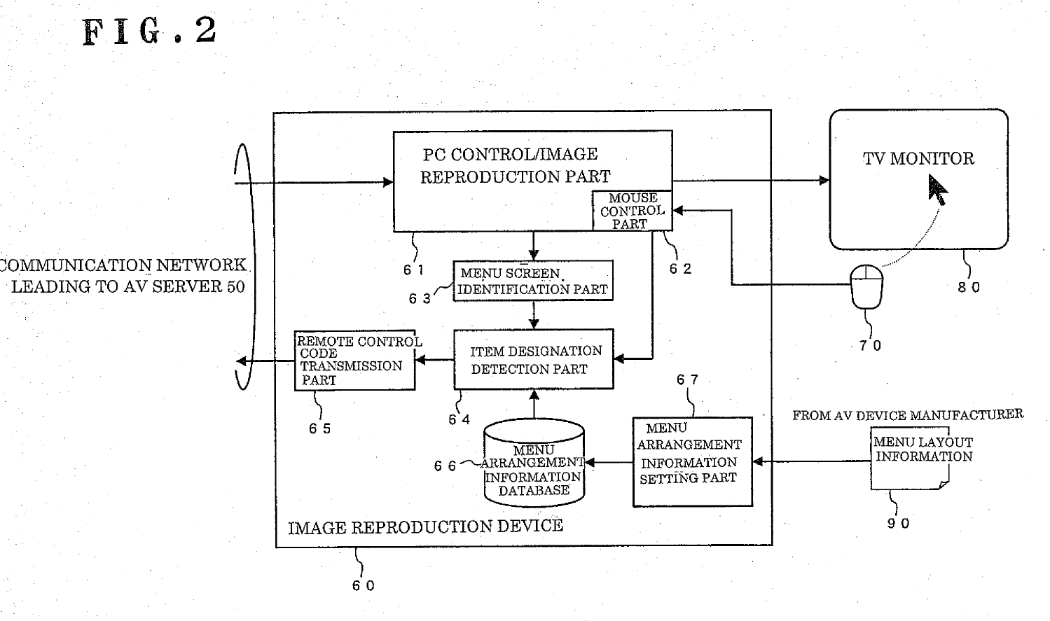

FIG. 3 is a diagram showing an installation example of the menu arrangement information database shown in FIG. 2;

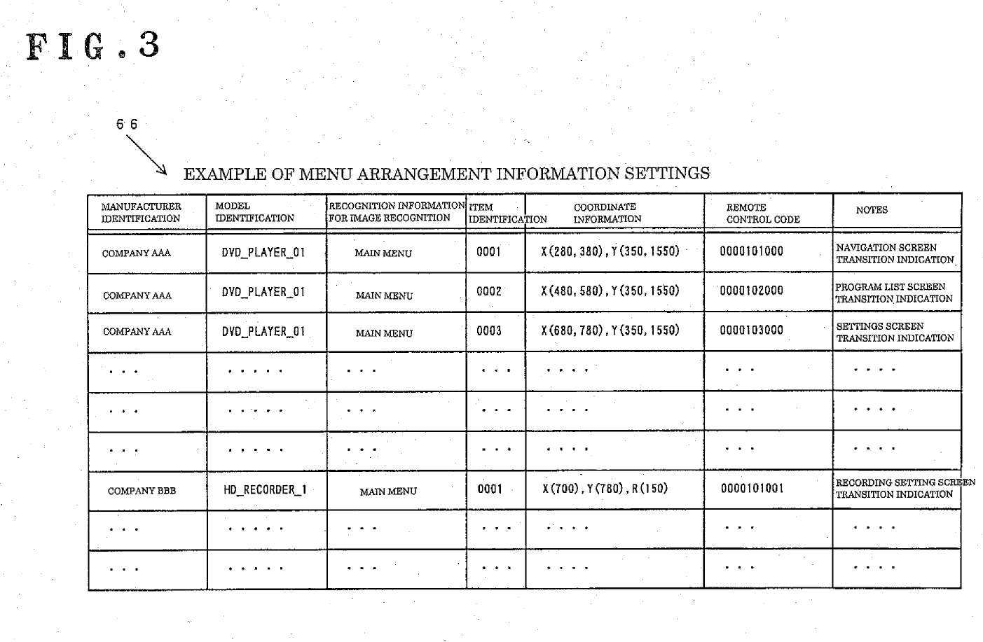

FIG. 4 is a sequence diagram showing the entire processing sequence including the image reproduction device according to the present invention;

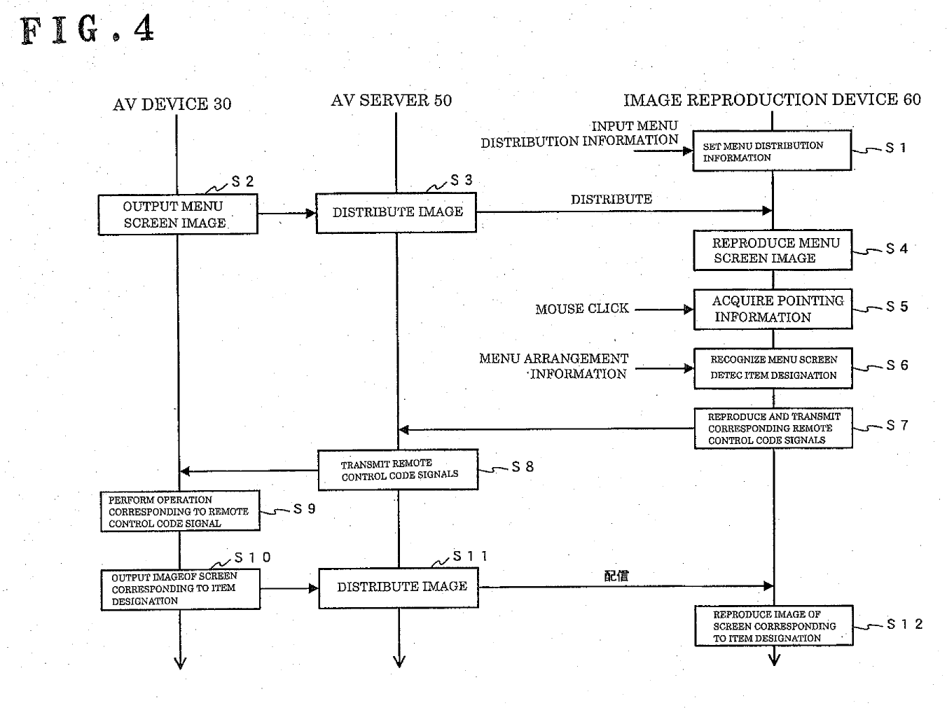

FIG. 5 is a diagram showing a display example of the image reproduction device of the present invention; and

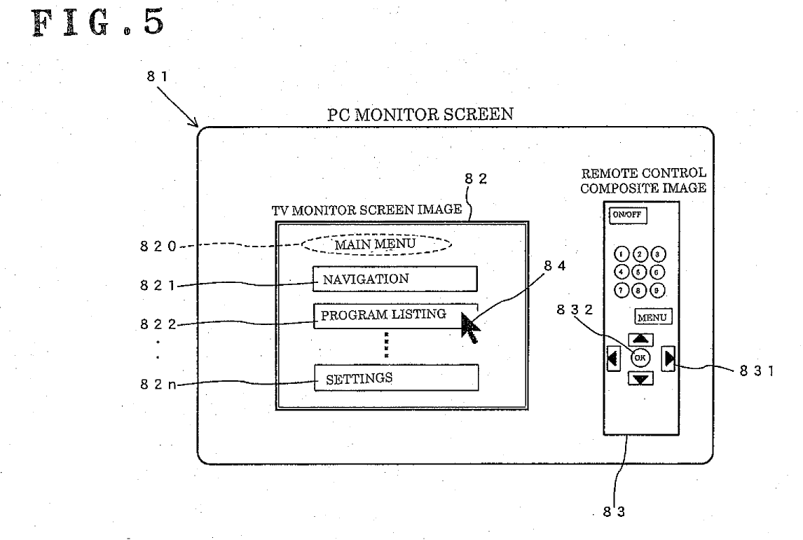

FIG. 6 is an explanatory diagram that presents the relationship between item coordinates and pointer coordinates on the TV monitor display screen.

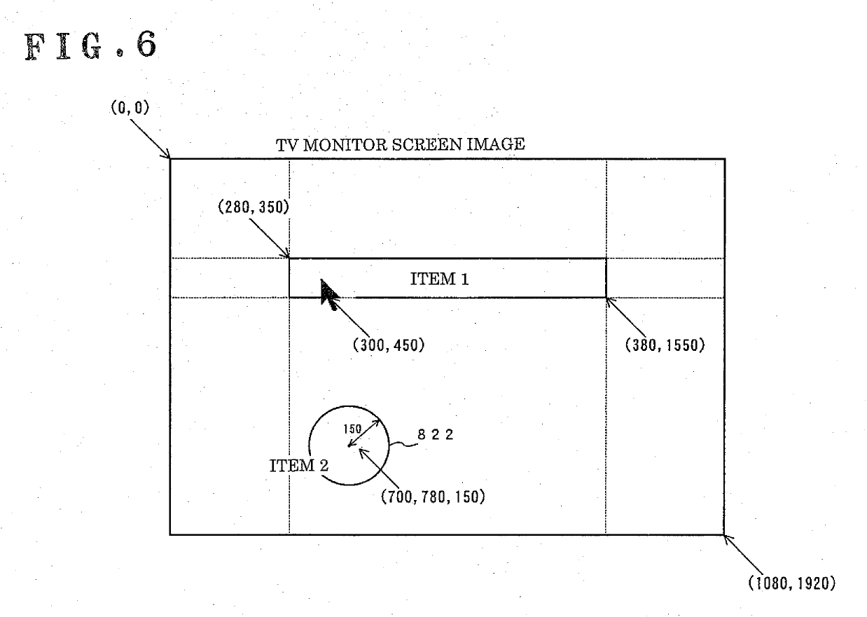

### EXPLANATION OF REFERENCE NUMERALS

20 Communication network
30 AV device
31 Receiving part
32 Remote controller
33 AV cable
40 AV monitor
50 AV server
51 Transmission part
60 Image reproduction device
61 Image reproduction part
62 Mouse control part
63 Menu screen identification part
64 Item designation detection part
65 Remote controller code transmission part
66 Menu arrangement information database
67 Menu arrangement information setting part
70 Mouse device (mouse)
80 PC monitor

1. An image reproduction device for acquiring image content and at least one menu image from an AV device via a communication network and reproducing the image content or menu image on a monitor screen, said image reproduction device characterized in comprising:
menu arrangement information storage means for storing, for each of said menu images, arrangement information for a plurality of menu selections on said menu image;
menu image identification means for identifying the in-reproduction menu image being reproduced;
menu selection branch determining means for determining, in accordance with a pointing information input corresponding to said monitor screen, one menu selection branch corresponding to said pointing information from among a plurality of menu selection branches in said in-reproduction menu image, on the basis of the arrangement information for said in-reproduction menu image; and
menu selection signal supply means for generating a menu selection signal corresponding to the menu selection branch that has been decided on, and supplying the signal to said AV device via said communication network.

2. The image reproduction device according to claim 1, characterized in that said menu image identification means identifies, using image recognition, a specific character sequence or specific shape contained in said in-reproduction menu image.

3. The image reproduction device according to claim 1, characterized in that said menu selection branch determining means decides upon said one menu selection branch by comparing pointer coordinates contained in said pointing information and coordinates of each menu selection branch contained in the arrangement information of said in-reproduction menu image.

4. The image reproduction device according to claim 1, characterized in that said menu selection signal supply means supplies said menu selection signal to said AV device via a communication route for a remote controller of said AV device.

5. The image reproduction device according to claim 4, characterized in further comprising means for simultaneously reproducing on said monitor screen said menu image and a composite image of said remote controller.

6. The image reproduction device according to claim 5, characterized in further comprising means for generating, in accordance with a pointing information input corresponding to the composite image of said remote controller, remote control code signals that correspond to content of said composite image, and for supplying the signals to said AV device as said menu selection signals via said communication network.

7. The image reproduction device according to claim 1, characterized in that said menu arrangement information storage means acquires said arrangement information via said communication network and stores the arrangement information.

8. An image reproduction device for acquiring image content and at least one menu image from an AV device via a communication network and reproducing the image content or menu image on a monitor screen, said image reproduction device characterized in comprising:
menu arrangement information storage part which stores, for each of said menu images, arrangement information for a plurality of menu selections on said menu image;
menu image identification part which identifies the in-reproduction menu image being reproduced;
menu selection branch determining part which determines, in accordance with a pointing information input corresponding to said monitor screen, one menu selection branch corresponding to said pointing information from among a plurality of menu selection branches in said in-reproduction menu image, on the basis of the arrangement information for said in-reproduction menu image; and
menu selection signal supply part which generates a menu selection signal corresponding to the menu selection branch that has been decided on, and supplying the signal to said AV device via said communication network.

9. The image reproduction device according to claim 8, wherein said menu image identification part identifies, using image recognition, a specific character sequence or specific shape contained in said in-reproduction menu image.

10. The image reproduction device according to claim 8, wherein said menu selection branch determining part decides upon said one menu selection branch by comparing pointer coordinates contained in said pointing information and coordinates of each menu selection branch contained in the arrangement information of said in-reproduction menu image.

11. The image reproduction device according to claim 8, wherein said menu selection signal supply part supplies said menu selection signal to said AV device via a communication route for a remote controller of said AV device.

12. The image reproduction device according to claim 11, further comprising a part which simultaneously reproduces on said monitor screen said menu image and a composite image of said remote controller.

13. The image reproduction device according to claim 12, further comprising a part which generates, in accordance with a pointing information input corresponding to the composite image of said remote controller, remote control code signals that correspond to content of said composite image, and supplies the signals to said AV device as said menu selection signals via said communication network.

14. The image reproduction device according to claim 8, wherein said menu arrangement information storage part acquires said arrangement information via said communication network and stores the arrangement information.
